(19) United States
(12) Patent Application Publication
(10) Pub. No.: US 2020/0307161 A1
(43) Pub. Date: Oct. 1, 2020

(54) CONDUCTIVE TEXTILE ARTICLE AND METHOD OF FABRICATING THE SAME

(71) Applicant: Chi-Wen KUO, Taipei City (TW)

(72) Inventor: Chi-Wen KUO, Taipei City (TW)

(21) Appl. No.: 16/831,054

(22) Filed: Mar. 26, 2020

(30) Foreign Application Priority Data
Mar. 26, 2019 (TW) 108110527

(51) Int. Cl. B32B 15/14; D03D 25/00; D04H 13/00; B32B 27/20; B32B 5/02; B32B 37/02; B32B 5/08; B32B 5/30; B32B 7/12; B32B 27/12; B32B 37/16

(52) U.S. Cl. CPC B32B 15/14; H01B 1/02; D04H 13/00; B32B 27/20; B32B 5/024; B32B 37/02; B32B 5/08; B32B 5/30; B32B 7/12; B32B 27/12; B32B 37/16; D10B 2401/16; B32B 2262/103; B32B 2305/30; B32B 2307/202; B32B 2457/00; B32B 2571/00; B32B 2437/00; B32B 2535/00; D03D 25/00

(57) ABSTRACT

A conductive textile according to the invention includes a fabric, a wire conductor and a metal sheet. The wire conductor is integrated with the fabric, and has a connection end. The metal sheet has a main body and a bent portion. The bent portion extends from the main body and is bent downward. The leading edge of the bent portion is flat or jagged. The metal sheet is pressed against an upper surface of the fabric and placed on the connection end. The main body is welded together with the connection end of the wire conductor by a welding process. The main body serves as a bonding pad.

### CROSS-REFERENCE TO RELATED APPLICATION

This utility application claims priority to Taiwan Application Serial Number 108110527, filed Mar. 26, 2019, which is incorporated herein by reference.

### BACKGROUND OF THE INVENTION

### 1. Field of the Invention

The present invention relates to a conductive textile article and a method of fabricating the same, and more in particular, to a conductive textile article with bonding pads and a method of fabricating the same.

### 2. Description of the Prior Art

Conductive textile articles have gradually been widely used, for example, in electro-warming clothes, thermal compresses, electromagnetic wave shielding, and the like. As with traditional electronic devices, conductive textile articles need to form electrical connections with external wires or electronic devices.

In general, conventional electronic devices have wires of thicker diameters, and the ends of these wires are easy to be picked up and peeled so that the ends of these wires are easy to be soldered. Different from conventional electronic devices, conductive textile articles are mostly woven from conductive yarns of thinner diameters and non-conductive yarns. If the conductive yarns are to be picked up, the textile structure of the conductive textile article is easily damaged. If the conductive yarn is covered with an insulating layer, it is difficult to peel the conductive yarn of thinner diameter. In the conductive textile article of the prior art, the ends or the connection ends of the conductive textile article of the conductive fabric are bonded together with wires or metal foil as electrodes in a soldering way, and the soldering way was mostly performed manually. The soldering way used in the conductive textile article of the prior art often results in abnormal resistance at the soldered joints due to poor soldering, and then the conductive textile article of the prior art generates hot spots after power is applied. In addition, the soldering way used in the conductive textile article of the prior art has poor soldering strength due to too small soldered joints. Obviously, the soldering quality of the conductive textile article of the prior art is not easy to be controlled, and therefore, the soldering way used in the conductive textile article of the prior art is not beneficial to mass production.

In addition, the textile structure of the conductive textile article is looser and more flexible than the substrate structure of the typical flexible circuit board. Therefore, the traditional wiring and soldering ways for typical flexible circuit boards cannot be implemented for conductive textile articles.

In addition, some conductive textile articles have insulation coatings attached to upper and lower surfaces thereof. How to develop conductive textile articles having bonding pads without the need of peeling the cover layer and destroying the textile structure is an urgent problem to be solved.

### SUMMARY OF THE INVENTION

Accordingly, one scope of the invention is to provide a conductive textile article with bonding pads and a method of fabricating the same.

A conductive textile article according to a preferred embodiment of the invention includes a fabric, a wire conductor and a metal sheet. The fabric has an upper surface and a lower surface. The wire conductor is integrated with the fabric, and has a connection end. The wire conductor is composed of a conductive yarn or a cured conductive glue. The wire conductor has a diameter in a range of from 0.3 mm to 3 mm. The conductive yarn includes a first coupling yarn, a second coupling yarn, a first twisted yarn, a doubled yarn, or a second twisted yarn. The first coupling yarn is constituted by at least one conductive core filament, a plurality of conductive short fibers, at least one non-conductive core filament or a plurality of non-conductive short fibers coupling with at least one metal wire. The second coupling yarn is constituted by at least one conductive core filament, a plurality of conductive short fibers, at least one non-conductive core filament or a plurality of non-conductive short fibers coupling with at least one rolled metal wire. The first twisted yarn is constituted by at least two metal wires or at least two carbon filaments twisting together. The doubled yarn is constituted by at least two metal wires or at least carbon filaments paralleling without any twist. The second twisted yarn is constituted by a combination among the first coupling yarn, the second coupling yarn, the first twisted yarn and the doubled yarn. The metal sheet includes a first main body and a first bent portion. The first bent portion extends from the first main body, and is bent downward. A first leading edge of the first bent portion is flat or jagged. The metal sheet is pressed against an upper surface of the fabric, and is placed on the connection end of the wire conductor. The first main body of the metal sheet is welded together with the connection end of the wire conductor by a welding process. The first main body of the metal sheet serves as a bonding pad.

Further, the metal sheet also includes a second main body and a second bent portion. The second main body extends from the first main body, and is bent onto the lower surface of the fabric. The second bent portion extends from the second main body, and is bent upward. A second leading edge of the second bent portion is flat or jagged. The second main body of the metal sheet is welded together with the connection end of the wire conductor and the first main body of the metal sheet by the welding process.

Further, the conductive textile article according to the preferred embodiment of the invention also includes a first polymer film. The first polymer film is attached on the lower surface of the fabric, and covers at least the connection end and an adjacent region of the wire conductor. During the welding process, a first portion of the first polymer film covering the connection end of the wire conductor is melted to be hollowed out, and the second main body of the metal sheet is welded together with the connection end of the wire conductor and the first main body through the hollowed first portion of the first polymer film.

Further, the conductive textile article according to the preferred embodiment of the invention also includes a second polymer film. The second polymer film is attached on the upper surface of the fabric, and covers at least the connection end the adjacent region of the wire conductor. During the welding process, a second portion of the second polymer film covering the connection end of the wire conductor is melted to be hollowed out, and the first main body of the metal sheet is welded together with the connection end of the wire conductor and the second main body through the hollowed second portion of the second polymer film.

In one embodiment, the first polymer film and the second polymer film can be respectively formed of a thermoplastic polyurethane, a hot melt adhesive, an ethylene-vinyl acetate copolymer, a styrene-based block copolymer, a metallocene polyene, an amorphous α-olefin copolymer, an olefin copolymer, a polyolefin, a polyamide, a polyurethane, a polypropylene, a polyethylene, a polyethylene terephthalate, a polyolefin, or a nylon.

A method, according to a preferred embodiment of the invention, of fabricating a conductive textile article, firstly, is to a weave a fabric. The fabric has an upper surface and a lower surface. Next, the method according to the preferred embodiment of the invention is to integrate a wire conductor with the fabric. The wire conductor has a connection end. The wire conductor is composed of a conductive yarn or a cured conductive glue. The wire conductor has a diameter in a range of from 0.3 mm to 3 mm. The conductive yarn includes a first coupling yarn, a second coupling yarn, a first twisted yarn, a doubled yarn, or a second twisted yarn. The first coupling yarn is constituted by at least one conductive core filament, a plurality of conductive short fibers, at least one non-conductive core filament or a plurality of non-conductive short fibers coupling with at least one metal wire. The second coupling yarn is constituted by at least one conductive core filament, a plurality of conductive short fibers, at least one non-conductive core filament or a plurality of non-conductive short fibers coupling with at least one rolled metal wire. The first twisted yarn is constituted by at least two metal wires or at least two carbon filaments twisting together. The doubled yarn is constituted by at least two metal wires or at least carbon filaments paralleling without any twist. The second twisted yarn is constituted by a combination among the first coupling yarn, the second coupling yarn, the first twisted yarn and the doubled yarn. Then, the method according to the preferred embodiment of the invention is to prepare a metal sheet. The metal sheet includes a first main body and a first bent portion. The first bent portion extends from the first main body, and is bent downward. A first leading edge of the first bent portion is flat or jagged. Afterwards, the method according to the preferred embodiment of the invention is to press the metal sheet against an upper surface of the fabric to place the metal sheet on the connection end of the wire conductor. Subsequently, the method according to the preferred embodiment of the invention is to apply a pressure on the metal sheet and the connection end of the wire conductor. Finally, the method according to the preferred embodiment of the invention is, by a welding process, to weld the first main body of the metal sheet together with the connection end of the wire conductor. The first main body serves as a bonding pad.

In one embodiment, the welding process can be a hot press welding process, a resistance welding process, a pulse resistance welding process, an ultrasonic welding process, an electromagnetic induction welding process, a plasma welding process, an arc welding process, or a laser welding process.

In one embodiment, the welding process can be performed in a power of from 200 W to 2000 W.

In one embodiment, the pressure has a range of form 0.5 bar to 10 bar.

Distinguishable from the prior arts, the conductive textile article and the method according to the invention can make bonding pads on the fabric without the need of peeling the cover layer and destroying the textile structure. Moreover, the method according to the invention is beneficial to mass production, and can be automated.

The advantage and spirit of the invention may be understood by the following recitations together with the appended drawings.

### BRIEF DESCRIPTION OF THE APPENDED DRAWINGS

FIG. 1 is a perspective view showing an example of a conductive textile article to be applied by a method according to a preferred embodiment of the invention.

FIG. 2 is a perspective view showing another example of a conductive textile article to be applied by the method according to the preferred embodiment of the invention.

FIG. 3 is a cross-sectional view showing an example of a conductive yarn, an essential element of the conductive textile article according to the invention.

FIG. 4 is a perspective view of a metal sheet, an essential element of the conductive textile article according to the invention.

FIG. 5 is a cross-sectional view of the conductive textile article of FIG. 1 taken along line A-A.

FIG. 6 is a cross-sectional view of the conductive textile article of FIG. 1 taken along line B-B.

FIG. 7 is a cross-sectional view of a modification of the conductive textile article according to the preferred embodiment of the invention.

FIG. 8 is a cross-sectional view of another modification of the conductive textile article according to the preferred embodiment of the invention.

### DETAILED DESCRIPTION OF THE INVENTION

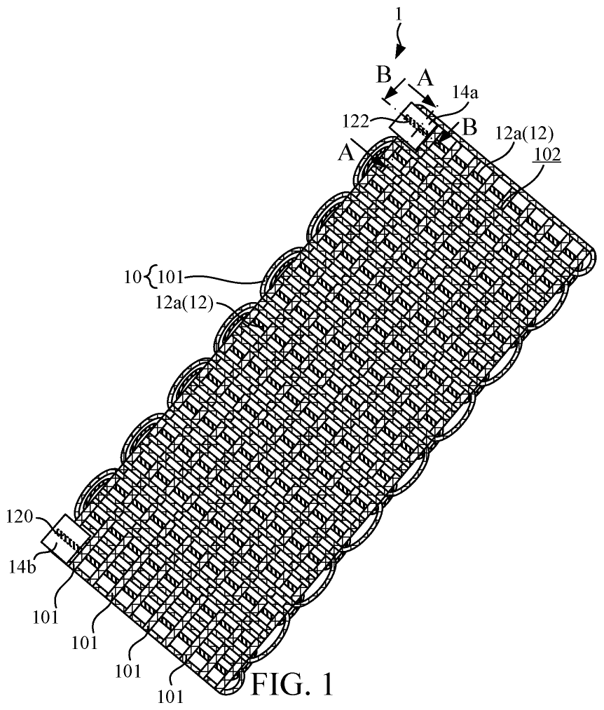

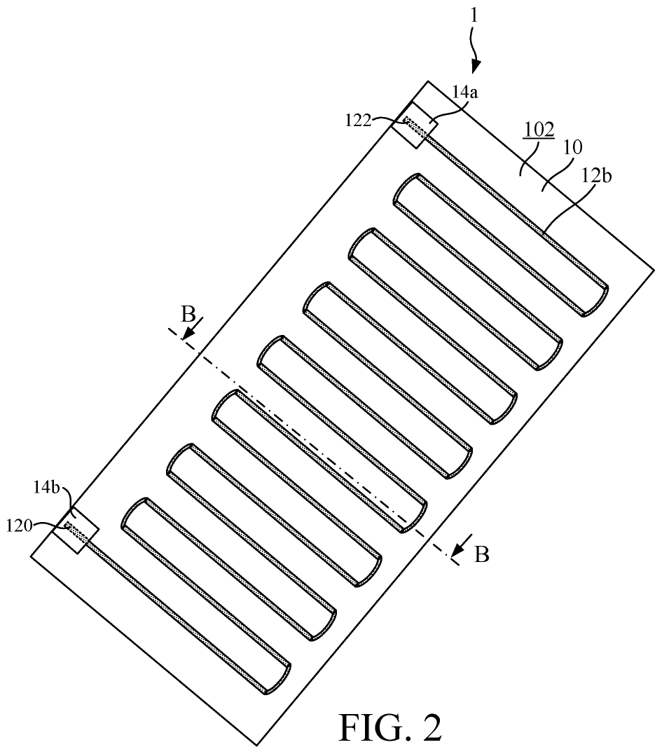

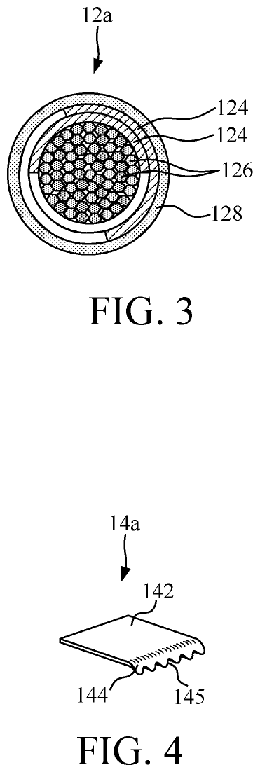

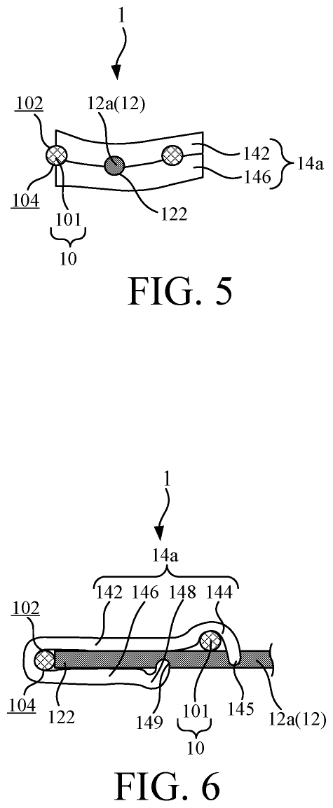

Referring to FIGS. 1 to 6, FIG. 1 schematically illustrates with a perspective view an example of a conductive textile article 1 according to the preferred embodiment of the invention. FIG. 2 schematically illustrates with a perspective view another example of a conductive textile article 1 according to the preferred embodiment of the invention. FIG. 3 is a cross-sectional view showing an example of a conductive yarn 12a (serving as a wire conductor 12), an essential element of the conductive textile article 1 according to the invention. FIG. 4 is a perspective view of a metal sheet 14a, an essential element of the conductive textile article 1 according to the invention. FIG. 5 is a cross-sectional view of the conductive textile article 1 of FIG. 1 taken along line A-A. FIG. 6 is a cross-sectional view of the conductive textile article 1 of FIG. 1 taken along line B-B.

As shown in FIGS. 1, 2 and 3, the conductive textile article 1 according to the preferred embodiment of the invention includes a fabric 10, the wire conductor 12 and the metal sheet (14a, 14b). The fabric 10 has an upper surface 102 and a lower surface 104. The wire conductor 12 is integrated with the fabric 10, and has a connection end 122. The wire conductor 12 (as shown in FIG. 1) is composed of a conductive yarn 12a or a cured conductive glue 12b. The wire conductor 12 has a diameter in a range of from 0.3 mm to 3 mm.

In the example as shown in FIG. 1, the fabric 10 of the conductive textile article 1 is woven from a plurality of non-conductive yarns 101. The conductive yarn 12a is woven with the plurality of non-conductive yarns 101. The conductive yarn 12a constitutes a loop. The conductive textile article 1 as shown in FIG. 1 is suitable, but not limited to, as a flexible electro-warming device. In FIG. 1, two conductive ends (122, 120) of the conductive yarn 12a woven on the fabric 10 are respectively provided with fixed metal sheets (14 a, 14 b), and are shown in FIG. 1.

In the example as shown in FIG. 2, the fabric 10 of the conductive textile article 1 is a woven fabric or a non-woven fabric. The cured conductive glue 12b is formed on the upper surface 102 of the fabric 10. The cured conductive glue 12b constitutes a loop. In FIG. 2, two conductive ends (122, 120) of the cured conductive glue 12b formed on the fabric 10 are respectively provided with fixed metal sheets (14 a, 14 b), and are shown in FIG. 1. In one embodiment, the cured conductive glue 12b may be formed of a conductive silver glue, a conductive copper glue, or the like.

Referring to FIG. 3, FIG. 3 schematically illustrates the structure of an example of the conductive yarn 12a. In one embodiment, the conductive yarn 12a includes a first coupling yarn, a second coupling yarn, a first twisted yarn, a doubled yarn, or a second twisted yarn. The first coupling yarn is constituted by at least one conductive core filament, a plurality of conductive short fibers, at least one non-conductive core filament or a plurality of non-conductive short fibers coupling with at least one metal wire. As shown in FIG. 3, the second coupling yarn (conductive yarn 12a) is constituted by a core yarn 126 coupling with at least one rolled metal wire 124. The core yarn 126 can be at least one conductive core filament, a plurality of conductive short fibers, at least one non-conductive core filament or a plurality of non-conductive core short fibers. The first twisted yarn is constituted by at least two metal wires or at least two carbon filaments twisting together. The doubled yarn is constituted by at least two metal wires or at least carbon filaments paralleling without any twist. The second twisted yarn is constituted by a combination among the first coupling yarn, the second coupling yarn, the first twisted yarn and the doubled yarn.

In one embodiment, materials used to fabricate aforesaid metal wires and rolled metal wires 124 can be copper, CuNi alloys, CuNiSi alloys, CuNiZn alloys, CuNiSn alloys, CuCr alloys, CuAg alloys, CuW alloys, silver, gold, lead, zinc, aluminum, nickel, brass, phosphor bronze, beryllium copper, nichrome, tantalum, tungsten, platinum, palladium, stainless steels, titanium, titanium alloys, Ni—Cr—Mo—W alloy, zirconium, zirconium alloys, HASTELLOY® alloys, nickel alloys, MONEL® alloys, ICONEL® alloys, FERRALIUM® alloy, NITRONIC® alloys, CARPENTER® alloy, or other commercial metals or alloys.

In one embodiment, materials used to fabricate aforesaid non-conductive core filaments and non-conductive core short fibers can be polyester, polyamide, polyacrylic, polyethylene, polypropylene, cellulose, protein, elastomeric, polytetrafluoroethylene, poly-p-phenylenebenzobisoxazole (PBO), polyetherketone, carbon, bamboo charcoal fiber, fiber with far-infrared radiation function or glass fiber, etc. or other commercial non-conductive fibers.

As shown in FIG. 4, the metal sheet 14a includes a first main body 142 and a first bent portion 144. The first bent portion 144 extends from the first main body 142, and is bent downward. A first leading edge 145 of the first bent portion 144 is flat or jagged (as shown in FIG. 4). Thereby, the first leading edge 145 of the first bent portion 144 can abut against the fabric 10, and can even engage the mesh of the fabric 10.

In one embodiment, the angle of the first bent portion 144 bending downward from the first main body 142 ranges from 0 degrees to 100 degrees.

As shown in FIG. 5, the metal sheet 14a is pressed against an upper surface 102 of the fabric 10, and is placed on the connection end 122 of the wire conductor 12. The first main body 142 of the metal sheet is welded together with the connection end 122 of the wire conductor 12 by a welding process. The first main body 142 of the metal sheet 14a serves as a bonding pad. The metal sheet 14a can be mated to be welded to the connection end 122 of the wire conductor 12 located at the edge or away from the edge of the fabric 10.

Also as shown in FIG. 3, in one embodiment, the conductive yarn 12a further includes a covered insulating layer 128. The covered insulating layer 128 has a thickness ranging from 50 μm to 100 μm. During the welding process, the insulating layer 128 at the connection end 122 of the conductive yarn 12a is melted.

Further, as shown in FIG. 6, the metal sheet 14a also includes a second main body 146 and a second bent portion 148. The second main body 146 extends from the first main body 142, and is bent onto the lower surface 104 of the fabric 10. The second bent portion 148 extends from the second main body 146, and is bent upward. A second leading edge 149 of the second bent portion 148 is flat or jagged. Thereby, the second leading edge 149 of the second bent portion 148 can abut against the fabric 10, and can even engage the mesh of the fabric 10. The second main body 146 of the metal sheet 14a is welded together with the connection end 122 of the wire conductor 12 and the first main body 142 of the metal sheet 14a by the welding process. The components and devices in FIG. 6 identical to those shown in FIG. 5 are given the same numerical notations, and will be not described in detail herein. The metal sheet 14a including the second main body 146 and the second bent portion 148 can be mated to be welded to the connection end 122 of the wire conductor 12 located at the edge of the fabric 10.

In one embodiment, the angle of the second bending portion 148 bending upward from the second main body 146 ranges from 0 degrees to 100 degrees.

In one embodiment, the length of the first main body 142 plus the length of the first bent portion 144 may be less than, equal to, or greater than the length of the second main body 146 plus the length of the second bent portion 148.

In one embodiment, each of the metal sheets (14a and 14b) may be a single-layered Cu sheet, multiple layers of Ag/Au layer/multi-layered Ag/Au/Sn/Ni layer/single-layered Cu sheet, single Sn layer/single-layered Cu sheet, single Ag layer/single-layered Cu sheet, single Au layer/single-layered Cu sheet, single Ag layer/single Ni layer/single-layered Cu sheet, single Au layer/single Ni layer/single Cu layer or single Sn layer/single Au layer/single Ag layer/single Ni layer/single-layered Cu sheet, single-layered stainless steel sheet, single-layered nickel sheet, single-layered aluminum sheet, single-layered aluminum alloy sheet, etc.

In one embodiment, the thickness of each of the metal sheets (14a and 14b) can range from 0.1 mm to 1 mm.

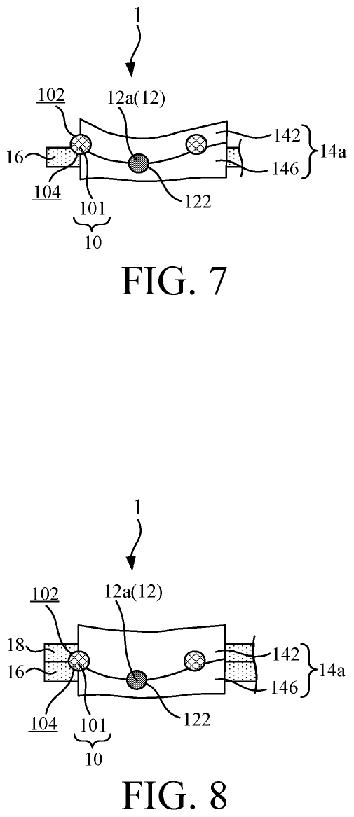

Referring to FIGS. 7 and 8, FIG. 7 and FIG. 8 respectively schematically illustrate with cross-sectional views a modification of the conductive textile article 1 according to the preferred embodiment of the invention. The definitions of the cross-sectional lines associated with the cross-sectional views shown in FIGS. 7 and 8 are the same as the line A-A in FIG. 1.

Further, as shown in FIG. 7, the conductive textile article 1 according to the preferred embodiment of the invention also includes a first polymer film 16. The first polymer film 16 is attached on the lower surface 104 of the fabric 10, and covers at least the connection end 122 and an adjacent region of the wire conductor 12. During the welding process, a first portion of the first polymer film 16 covering the connection end 122 of the wire conductor 12 is melted to be hollowed out, and the second main body 146 of the metal sheet is welded together with the connection end 122 of the wire conductor 12 and the first main body 142 through the hollowed first portion of the first polymer film 16. The first polymer film 16 can also be attached to cover the whole of the lower surface 104 of the fabric 10. The components and devices in FIG. 7 identical to those shown in FIG. 5 and FIG. 6 are given the same numerical notations, and will be not described in detail herein.

Further, as shown in FIG. 8, the conductive textile article 1 according to the preferred embodiment of the invention also includes a second polymer film 18. The second polymer film 18 is attached on the upper surface 102 of the fabric 10, and covers at least the connection end 122 the adjacent region of the wire conductor 12. During the welding process, a second portion of the second polymer film 18 covering the connection end 122 of the wire conductor 12 is melted to be hollowed out, and the first main body 142 of the metal sheet is welded together with the connection end 122 of the wire conductor 12 and the second main body 146 through the hollowed second portion of the second polymer film 18. The second polymer film 18 can also be attached to cover the whole of the upper surface 102 of the fabric 10. The components and devices in FIG. 8 identical to those shown in FIG. 5, FIG. 6 and FIG. 7 are given the same numerical notations, and will be not described in detail herein.

In one embodiment, the first polymer film 16 and the second polymer film 18 can be respectively formed of a thermoplastic polyurethane, a hot melt adhesive, an ethylene-vinyl acetate copolymer, a styrene-based block copolymer, a metallocene polyene, an amorphous α-olefin copolymer, an olefin copolymer, a polyolefin, a polyamide, a polyurethane, a polypropylene, a polyethylene, a polyethylene terephthalate, a polyolefin, or a nylon.

In one embodiment, each of the first polymer film 16 and the second polymer film 18 respectively has a thickness ranging from 0.1 to 1 mm.

Further, the first polymer film 16 and the second polymer film 18 are respectively doped with a plurality of filled particles of from 0% to 20% by weight. The plurality of filled particles may be far-infrared emitting particles, alumina particles, titanium dioxide particles, silicon dioxide particles, calcium carbonate particles, graphite particles, graphene particles, or a combination of the foregoing various particles.

A method, according to a preferred embodiment of the invention, of fabricating a conductive textile article 1, firstly, is to a weave a fabric 10. The fabric 10 has an upper surface 102 and a lower surface 104.

Next, the method according to the preferred embodiment of the invention is to integrate a wire conductor 12 with the fabric 10. The wire conductor 12 has a connection end 122. The wire conductor 12 is composed of a conductive yarn or a cured conductive glue. The wire conductor 12 has a diameter in a range of from 0.3 mm to 3 mm. The conductive yarn includes a first coupling yarn, a second coupling yarn, a first twisted yarn, a doubled yarn, or a second twisted yarn. The first coupling yarn is constituted by at least one conductive core filament, a plurality of conductive short fibers, at least one non-conductive core filament or a plurality of non-conductive short fibers coupling with at least one metal wire. The second coupling yarn is constituted by at least one conductive core filament, a plurality of conductive short fibers, at least one non-conductive core filament or a plurality of non-conductive short fibers coupling with at least one rolled metal wire. The first twisted yarn is constituted by at least two metal wires or at least two carbon filaments twisting together. The doubled yarn is constituted by at least two metal wires or at least carbon filaments paralleling without any twist. The second twisted yarn is constituted by a combination among the first coupling yarn, the second coupling yarn, the first twisted yarn and the doubled yarn.

Then, the method according to the preferred embodiment of the invention is to prepare a metal sheet 14a. The metal sheet 14a includes a first main body 142 and a first bent portion 144. The first bent portion 144 extends from the first main body 142, and is bent downward. A first leading edge 145 of the first bent portion 144 is flat or jagged. Thereby, the first leading edge 145 of the first bent portion 144 can abut against the fabric 10, and can even engage the mesh of the fabric 10.

Afterwards, the method according to the preferred embodiment of the invention is to press the metal sheet 14a against an upper surface 102 of the fabric 10 to place the metal sheet on the connection end 122 of the wire conductor 12.

Subsequently, the method according to the preferred embodiment of the invention is to apply a pressure on the metal sheet 14a and the connection end 122 of the wire conductor 12.

Finally, the method according to the preferred embodiment of the invention is, by a welding process, to weld the first main body 142 of the metal sheet together with the connection end 122 of the wire conductor 12. The first main body 142 serves as a bonding pad.

In one embodiment, the welding process can be a hot press welding process, a resistance welding process, a pulse resistance welding process, an ultrasonic welding process, an electromagnetic induction welding process, a plasma welding process, an arc welding process, or a laser welding process.

In one embodiment, the welding process can be performed in a power of from 200 W to 2000 W.

In one embodiment, the pressure has a range of form 0.5 bar to 10 bar.

In one embodiment, the metal sheet 14a also includes a second main body 146 and a second bent portion 148. The second main body 146 extends from the first main body 142, and is bent onto the lower surface 104 of the fabric 10. The second bent portion 148 extends from the second main body 146, and is bent upward. A second leading edge 149 of the second bent portion 148 is flat or jagged. Thereby, the second leading edge 149 of the second bent portion 148 can abut against the fabric 10, and can even engage the mesh of the fabric 10. During the welding process, the second main body 146 of the metal sheet 14a is welded together with the connection end 122 of the wire conductor 12 and the first main body 142 of the metal sheet 14a.

In one embodiment, a first polymer film 16 is attached on the lower surface 104 of the fabric 10, and covers at least the connection end 122 and an adjacent region of the wire conductor 12. During the welding process, a first portion of the first polymer film 16 covering the connection end 122 of the wire conductor 12 is melted to be hollowed out, and the second main body 146 of the metal sheet is welded together with the connection end 122 of the wire conductor 12 and the first main body 142 through the hollowed first portion of the first polymer film 16. The first polymer film 16 can also be attached to cover the whole of the lower surface 104 of the fabric 10.

In one embodiment, a second polymer film 18 is attached on the upper surface 102 of the fabric 10, and covers at least the connection end 122 the adjacent region of the wire conductor 12. During the welding process, a second portion of the second polymer film 18 covering the connection end 122 of the wire conductor 12 is melted to be hollowed out, and the first main body 142 of the metal sheet is welded together with the connection end 122 of the wire conductor 12 and the second main body 146 through the hollowed second portion of the second polymer film 18. The second polymer film 18 can also be attached to cover the whole of the upper surface 102 of the fabric 10.

Distinguishable from the prior arts, the conductive textile article and the method according to the invention can make bonding pads on the fabric without the need of peeling the cover layer and destroying the textile structure. Moreover, the method according to the invention is beneficial to mass production, and can be automated.

With detailed description of the invention above, it is clear that the conductive textile article and the method according to the invention can make bonding pads on the fabric without the need of peeling the cover layer and destroying the textile structure. Moreover, the method according to the invention is beneficial to mass production, and can be automated.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A conductive textile article, comprising:
a fabric, having an upper surface and a lower surface;
a wire conductor, being integrated with the fabric and having a connection end, wherein the wire conductor is composed of a conductive yarn or a cured conductive glue, the wire conductor has a diameter in a range of from 0.3 mm to 3 mm, the conductive yarn comprises one selected from the group consisting of a first coupling yarn, a second coupling yarn, a first twisted yarn, a doubled yarn, and a second twisted yarn, said first coupling yarn is constituted by at least one conductive core filament, a plurality of conductive short fibers, at least one non-conductive core filament or a plurality of non-conductive short fibers coupling with at least one metal wire, said second coupling yarn is constituted by at least one conductive core filament, a plurality of conductive short fibers, at least one non-conductive core filament or a plurality of non-conductive short fibers coupling with at least one rolled metal wire, said first twisted yarn is constituted by at least two metal wires or at least two carbon filaments twisting together, said doubled yarn is constituted by at least two metal wires or at least carbon filaments paralleling without any twist, said second twisted yarn is constituted by a combination among said first coupling yarn, said second coupling yarn, said first twisted yarn and said doubled yarn; and
a metal sheet, comprising a first main body and a first bent portion, the first bent portion extending from the first main body and being bent downward, a first leading edge of the first bent portion being flat or jagged, wherein the metal sheet is pressed against an upper surface of the fabric and placed on the connection end, the first main body is welded together with the connection end of the wire conductor by a welding process, the first main body serves as a bonding pad.

2. The conductive textile article of claim 1, wherein the metal sheet further comprises a second main body and a second bent portion, the second main body extends from the first main body and is bent onto the lower surface of the fabric, the second bent portion extends from the second main body and is bent upward, a second leading edge of the second bent portion is flat or jagged, the second main body is welded together with the connection end of the wire conductor and the first main body by the welding process.

3. The conductive textile article of claim 2, further comprising a first polymer film being attached on the lower surface of the fabric and covering at least the connection end and an adjacent region of the wire conductor, during the welding process, a first portion of the first polymer film covering the connection end of the wire conductor is melted to be hollowed out, and the second main body is welded together with the connection end of the wire conductor and the first main body through the hollowed first portion of the first polymer film.

4. The conductive textile article of claim 3, further comprising a second polymer film being attached on the upper surface of the fabric and covering at least the connection end the adjacent region of the wire conductor, during the welding process, a second portion of the second polymer film covering the connection end of the wire conductor is melted to be hollowed out, and the first main body is welded together with the connection end of the wire conductor and the second main body through the hollowed second portion of the second polymer film, the first polymer film and the second polymer film are respectively formed of one selected from the group consisting of a thermoplastic polyurethane, a hot melt adhesive, an ethylene-vinyl acetate copolymer, a styrene-based block copolymer, a metallocene polyene, an amorphous α-olefin copolymer, an olefin copolymer, a polyolefin, a polyamide, a polyurethane, a polypropylene, a polyethylene, a polyethylene terephthalate, a polyolefin, and a nylon.

5. The conductive textile article of claim 4, wherein the first polymer film and the second polymer film are respectively doped with a plurality of filled particles of from 0% to 20% by weight, the plurality of filled particles comprise selected from the group consisting of far-infrared emitting particles, alumina particles, titanium dioxide particles, silicon dioxide particles, calcium carbonate particles, graphite particles, graphene particles, and combinations therebetween.

6. A method of fabricating a conductive textile article, comprising the steps of:
(a) weaving a fabric having an upper surface and a lower surface;
(b) integrating a wire conductor with the fabric, wherein the wire conductor has a connection end, the wire conductor is composed of a conductive yarn or a cured conductive glue, the wire conductor has a diameter in a range of from 0.3 mm to 3 mm, the conductive yarn comprises one selected from the group consisting of a first coupling yarn, a second coupling yarn, a first twisted yarn, a doubled yarn, and a second twisted yarn, said first coupling yarn is constituted by at least one conductive core filament, a plurality of conductive short fibers, at least one non-conductive core filament or a plurality of non-conductive short fibers coupling with at least one metal wire, said second coupling yarn is constituted by at least one conductive core filament, a plurality of conductive short fibers, at least one non-conductive core filament or a plurality of non-conductive short fibers coupling with at least one rolled metal wire, said first twisted yarn is constituted by at least two metal wires or at least two carbon filaments twisting together, said doubled yarn is constituted by at least two metal wires or at least carbon filaments paralleling without any twist, said second twisted yarn is constituted by a combination among said first coupling yarn, said second coupling yarn, said first twisted yarn and said doubled yarn; and
(c) preparing a metal sheet, wherein the metal sheet comprises a first main body and a first bent portion, the first bent portion extends from the first main body and is bent downward, a first leading edge of the first bent portion is flat or jagged;
(d) pressing the metal sheet against an upper surface of the fabric to place the metal sheet on the connection end of the wire conductor;
(e) applying a pressure on the metal sheet and the connection end of the wire conductor; and
(f) by a welding process, welding the first main body together with the connection end of the wire conductor, wherein the first main body serves as a bonding pad.

7. The method of claim 6, wherein the welding process is one selected form the group consisting of a hot press welding process, a resistance welding process, a pulse resistance welding process, an ultrasonic welding process, an electromagnetic induction welding process, a plasma welding process, an arc welding process, and a laser welding process, the welding process is performed in a power of from 200 W to 2000 W.

8. The method of claim 7, wherein the pressure has a range of form 0.5 bar to 10 bar.

9. The method of claim 8, wherein the metal sheet further comprises a second main body and a second bent portion, the second main body extends from the first main body and is bent onto the lower surface of the fabric, the second bent portion extends from the second main body and is bent upward, a second leading edge of the second bent portion is flat or jagged, in step (f), the second main body is welded together with the connection end of the wire conductor and the first main body.

10. The method of claim 9, wherein a polymer film is attached on the lower surface of the fabric and covering at least the connection end and an adjacent region of the wire conductor, in step (f), a portion of the polymer film covering the connection end of the wire conductor is melted to be hollowed out, and the second main body is welded together with the connection end of the wire conductor and the first main body through the hollowed portion of the polymer film.
